(19) United States
(12) Patent Application Publication
(10) Pub. No.: US 2010/0153087 A1
(43) Pub. Date: Jun. 17, 2010

(54) TECHNIQUES FOR GENERATING A REUSABLE TEST SCRIPT FOR A SINGLE USER PERFORMANCE TEST

(76) Inventors: Sergej Kirtkow, Hockenheim (DE); Markus Kohler, Kaierslautern (DE); Heike Schwab, Heidelberg (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/334,405

(22) Filed: Dec. 12, 2008

(51) Int. Cl. G06F 9/44

(52) U.S. Cl. 703/21

(57) ABSTRACT

Techniques for generating a reusable script for a single user performance test of a network application. A description of a single user performance test is generated based upon a group of data describing a functional test and a group of data describing commands of a performance test tool. In one embodiment, a functional test tool generates signals based on the description of a single user performance test to simulate to a performance test tool user interactions with a user interface of the performance test tool to manage a performance test session to test the network application. In another embodiment, the functional test tool generates signals simulating user interactions with a user interface of the network application during the performance test session.

### BACKGROUND OF THE INVENTION

1. Field of the Invention

Embodiments of the invention relate generally to performance testing of software. More particularly, select embodiments of the invention relate to generating a reusable script for the recording of a single user performance test of a network application.

2. Background Art

In software development, functional tests may evaluate whether a given software application (or portion thereof) implements an intended functionality offered in a graphical user interface (UI). Various tools are presently used to automatically test the functionality of a UI. Examples of these functional test tools include HP WinRunner® and Compuware® TestPartner®. Functional test tools typically record as a script selected user actions within a UI of an application under test, modify the recorded scripts if necessary, and then automatically replay the user actions according to the scripts. Traditionally, the reuse of recorded functional test scripts has been limited in their ability to accommodate modifications to a UI and/or to be combined into longer sequences of user interactions.

Separate from, or in addition to, testing a functionality of an application, it is often useful to evaluate the performance of a system—e.g. an application server system—in the course of the system providing said functionality. This is accomplished via a performance test to determine performance indicators—such as resource consumption and/or runtime response—associated with the system's implementation of the UI. Performance tests are useful to evaluate scalability of an application service in a network context, for example. The provisioning of a network application by an application server system can be tested by a performance test tool to evaluate any of a variety of loads on the server system such as processing power, memory usage and/or networking bandwidth. Performance test tools such as HP LoadRunner® typically analyze UI performance by recording several users' interactions with a network application. From these recorded interactions, a script may be generated which can be used to emulate the load of multiple users' UI interactions, e.g. by replaying the network traffic to the server system.

Typically, a UI includes one or more UI elements to provide user access to respective functionalities of a network application. As updates or new versions of the network application are introduced, the internal data processing to implement the functionalities accessed by various UI elements may change. Often the internal data processing accessed via a particular UI element may change regularly from one network application update to the next—e.g. while an appearance of that particular UI element as displayed to a user may change less frequently, if ever. Existing tools for performance testing typically reference the internal data processing and/or data communications in describing user interactions with a network application, and so are limited in their ability to accommodate changes to, or new versions of, the internal data processing. Moreover, the reuse of performance test scripts has typically been inadequate to sufficiently accommodate variety across sequential users' UI interactions and/or variety across multiple iterations of a single user's UI interactions. Consequently, performance scripts often have to be rerecorded separately to account for even small changes in the system to be tested. For extensive scripts, a large amount of high quality human resources, mostly requiring special programming knowledge, is usually needed to maintain recorded performance test scripts or to re-record certain scripts.

Thus, functional testing and/or performance testing of applications can be very resource intense and time consuming parts of software development. This is particularly so in the case of dynamic applications such as the SAP Netweaver® suite of applications provided by SAP Aktiengesellschaft, in which a UI's appearance is dynamically created depending on the user activity (or activity of other users, for example) and where the properties of internal data processing change frequently.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating select elements of a system to implement performance testing according to an embodiment.

FIG. 2 is a block diagram illustrating select elements of a system to generate a description of a single user performance test according to an embodiment.

FIG. 3 is a block diagram illustrating select elements of a system to implement a single user performance test according to an embodiment.

FIG. 4 is a block diagram illustrating select elements of a process to generate a description of a single user performance test according to an embodiment.

FIG. 5 is a block diagram illustrating select elements of a system to generate a description of a multiple user performance test according to an embodiment.

FIG. 6 is a block diagram illustrating select elements of a system to implement a multiple user performance test according to an embodiment.

FIG. 7 is a block diagram illustrating select elements of a process to generate a description of a multiple user performance test according to an embodiment.

FIG. 8 is a block diagram illustrating select elements of a data processing device according to an embodiment.

FIG. 9 is a block diagram of a client-server system subject to a performance test according to an embodiment.

FIG. 10 is a block diagram of a client-server system subject to a performance test according to an embodiment.

### DETAILED DESCRIPTION

Methods, apparatuses, and systems enable the generation of a reusable test script for implementing a performance test. A description of a functional test may be provided to a test description generator dedicated to generating and storing in a memory a description of a performance test—e.g. a performance test script—for a network application. The functional test may describe one or more user interactions with a UI of the network application under test. For example, one or more of the user interactions may each be described in terms of a command based on a respective functional definition in a functional library—e.g. a library of a domain specific language (DSL). In an embodiment, the DSL specifies an at least partially context-independent, or ‘abstracted’, definition of a function representing an interaction of a user with the network application—e.g. a definition which is independent of one or more process logic contexts which the network application under test specifies for a particular implementation of the defined function.

In an embodiment, the description of the performance test is generated by combining information in the description of a functional test with performance test information describing commands to operate a performance test tool. This combination of information may, for example, result in a description of a performance test which, when provided to a functional test tool, allows the functional test tool to automate a performance test—e.g. by both simulating user interactions with a performance test tool implementing a performance test session and simulating user interactions with the network application under test during said performance test session. All performance test results, or alternatively, selected ones of the results, may then be presented to a developer or other user for analysis. Additionally or alternatively, the description of the performance test may be reused to performance test a modified version of the network application and/or a modified version of a user interaction with said network application.

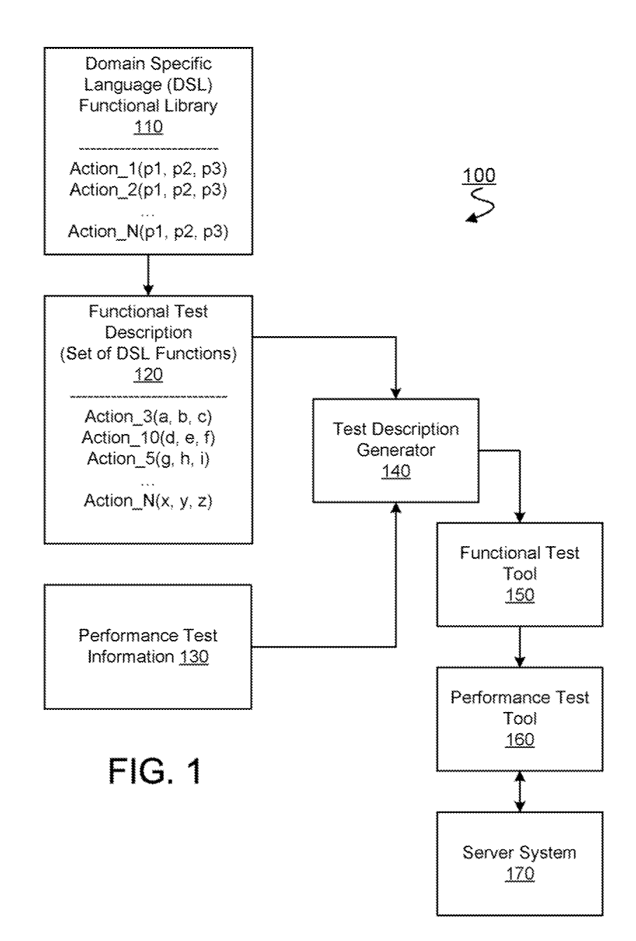

FIG. 1 illustrates select elements of a system 100 to implement performance testing according to an embodiment. In an embodiment, system 100 may comprise a test description generator 140 to generate a description of a performance test for automated performance testing of a particular application. Test description generator 140 may include any of a variety of combinations of routines, method calls, objects, threads, state machines, ASICs and/or similar software and/or hardware logic to receive and process data, referred to herein as a functional test description, which describes one or more commands to invoke a functionality of, or otherwise interact with, a UI of an application under test. As used herein, a “functional test description” refers to a description of one or more commands to invoke network application functionality which are capable of being used as a functional test of a UI of the network application—e.g. regardless of whether said description has been or is actually intended to be used for a functional test of the application. For example, test description generator 140 may use functional test description data to generate a performance test description to automate performance testing of a UI which is already known to provide its intended functionality, although the efficiency of a server providing said functionality has yet to be evaluated.

By way of illustration, test description generator 140 may receive as a first group of data a functional test description 120 describing one or more functional commands to interact with a user interface of an application server—e.g. server system 170. In an embodiment, the description of commands in functional test description 120 may be according to a library of functions—e.g. a functional library 110—describing functions in a domain specific language (DSL). As used herein, DSL refers to a computer language that is dedicated to a particular problem domain—e.g. dedicated to a particular representation technique and/or a particular solution technique for problems experienced within the domain of a network application service. A DSL may be distinguished, for example, from a general purpose computer language intended for use across various domains. In a particular embodiment, a DSL may be targeted to representing user interactions with a network application via a UI. Implementing a DSL may require custom developing of software libraries and/or syntax appropriate for the techniques to be applied in the problem domain. Implementing a DSL may further require custom generation of a parser for commands generated based on these libraries and/or syntax. By way of illustration, DSL tools are included in the Microsoft Visual Studio® software development kit (SDK). Functional library 110 may include functions to interact with different UI implementations, e.g. web-based, JAVA, Windows UI, etc. Alternatively or in addition, functional library 110 may be extended to include functions suitable for control elements of specialized implementations.

At least one advantage is that a DSL may provide a level of abstraction for representing an interaction in order to avoid the complexity of a lower level programming language, for example. In an embodiment, functional library 110 may include a definition for a type of user interaction with a network application which is independent of one or more process logic contexts of the network application that support the interaction. For example, a function of functional library 110 may generically represent a single user action to interact with a type of UI element—such as “clicking on a link” or “setting the value for a textbox”. The definition of the function in functional library 110 may include parameters to describe to a desired level of specificity/abstraction an instance of the type of UI element. More particularly, these parameters may be used to create a description of a user action which distinguishes one instance of the UI element—e.g. from instances of other UI elements of a particular user session—while remaining independent of (e.g. agnostic with respect to) other parameters describing the application's internal data processing to implement functionality accessed via the UI element.

In an embodiment, a functional library may describe functions to a level of abstraction which only provides for (1) unique identification of a particular UI element (e.g. a particular text box, menu, radio button, check box, drop-down list, etc.) which is the subject of an interaction, and (2) a description of the user interaction (click, input value, select value, cursor over, toggle value, etc.) with the identified UI element. By way of illustration, a function definition Click_Button(<buttonname>) may provide such an abstracted description of a user click on a particular button, e.g. assuming the button in question is uniquely identifiable by some <buttonname> value. Alternatively or in addition, a function definition Enter_Field(<fieldID>, <value>) may similarly provide such an abstracted description of a user entering a particular <value> into a field uniquely identifiable by some <fieldID> value.

For some function definitions, numerous parameters may be needed to uniquely identify a UI element. For example, a “Click_Link(<framename>; <linkname>; <location>)” function of functional library 110 may receive three parameters. The parameter <framename> may specify the UI frame on which the requested link is displayed. The parameter <linkname> may specify which UI link of a UI frame should be clicked. The <linkname> property is usually unique. In case the parameter <linkname> is not unique, the parameter <location> may specify the link that should be clicked, e.g. by a location of a link in a frame. Any of a variety of additional or alternative combinations of parameters may be used in a definition of a function in functional library 110. The particular values for the parameters <framename> and <linkname> (and <location> where applicable) may be sufficient to distinguish one instance of the link as implemented in a particular user session, while allowing the description of the user interaction to be reused to describe interactions with other instances of the link in other contexts—e.g. in other user sessions and/or for updated versions of the internal data processing invoked by Click Link. The same may be true for other DSL function definitions such as Click_Button and/or Enter_Field.

By defining functions in at least partially context-independent terms, a DSL functional library 110 can be used construct a functional test description 120 which is applicable across various implementations of a UI. Moreover, by describing a user's interaction with a network application only in terms of interactions with UI elements, functional test description 120 may be used to generate a description of a performance test which does not need to be updated for revisions to the network application which merely update internal data processing—e.g. without changing an appearance of UI elements by which internal data processing is to be invoked. Functional library 110 may be easy to maintain, as the number of functions may simply correspond to the number of UI control elements of the UI. Another benefit of describing UI interactions according to a DSL functional library is that creating functional test description 120 requires little detailed programming knowledge. For example, a developer may build a model of a sequence of user interactions simply by placing DSL function commands associated with the interactions in a corresponding order with the correct parameters. This enables a test designer without extensive programming knowledge to easily build up functional test description 120. Such a building of functional test description 120 may be implemented, for example, via an interface such as that for the SAP NetWeaver® TestSuite provided by SAP Aktiengesellschaft.

In addition to functional test description 120, test description generator 140 may further receive and process data describing commands to operate a performance test tool capable of recording performance test information of a system implementing the UI of an application under test. By way of illustration, test description generator 140 may receive as a second group of data performance test information 130 including, for example, a description of one or more commands to operate a performance test tool 160. As with functional test description 120, performance test information 130 may describe commands according to DSL command definitions which are independent of one or more process logic contexts—e.g. one or more process logic contexts of performance test tool 160. In an embodiment, a functional library used to generate command descriptions of performance test information 130 may include functional library 110 and/or an alternate functional library (not shown).

Based on the received functional test description 120 and the received performance test information 130, test description generator 140 may generate a performance test description for use in automating a performance test of an application under test—e.g. an application of sever system 170. In an embodiment, generating the performance test description may include combining commands of functional test description 120—e.g. commands which simulate user interactions with a UI of an application of server system 170—with commands described in performance test information 130 which direct performance test tool 160 in capturing performance indicator values related to these user interactions. For example, test description generator 140 may selectively interleave or otherwise insert within a performance test description a group of commands of functional test description 120 with a group of commands to operate performance test tool 160. This combining of sets of commands may include test description generator 140 generating, retrieving or otherwise accessing data to determine the combining, e.g. data determining an ordering of commands, iterations of commands, parameter passing for the commands, etc.

In an embodiment, the data to determine the combining of functional test description 120 and performance test information 130 may be received as input from a developer and/or as other configuration information (not shown) available to test description generator 140. For example, the test description generator 140 may access data describing operations of a user session—and/or a number of iterations thereof—which are to be performed before certain performance test evaluations are made. By way of illustration, a simulation of a single user's interactions with a UI may, in order to achieve performance test results which are representative of real world performance, have to allow an application server to ‘warm up’—e.g. to reach some steady state of data processing or other operation before recording user interactions and/or before determining values of performance indicators associated with providing a network application service. Test description generator 140 may access additional configuration information in order to generate a description of a performance test which accounts for steady state operation of an application server system. In addition to combining sets of commands from functional test description 120 and performance test information 130, test description generator may, in an embodiment, perform additional processing of the combination of commands—e.g. by translating the combination of commands so that the generated performance test description may be provided in a language suitable for use by a functional test tool 150—e.g. a Compuware® TestPartner® tool. Such a translation may be performed, for example, by test description generator 140 referring to a library (not shown) of commands for a scripting language used by functional test tool 150.

The generated description of the performance test may then be provided from test description generator 140 to functional test tool 150, whereupon functional test tool 150 may automate the execution of commands to implement a performance test. In an embodiment, functional test tool 150 may automate, according to script commands of the received performance test description, the providing of input for performance test tool 160 to direct how performance test tool 160 is to manage—e.g. prepare, initiate, modify, operate, and/or complete—the performance test session which is to detect the values of performance indicators for a network application under test. In addition, functional test tool 150 may also automate, according to script commands of the received performance test description, performance test tool 160 providing input for the UI during the performance test session. In other words, one type of signals from functional test tool 150 to performance test tool 160 may simulate user interactions with performance test tool 160 to prepare a performance test session, while another type of signals from functional test tool 150 to performance test tool 160 may simulate user interactions with the UI of the network application under test during the performance test session. Performance test tool 160 may respond to these signals from functional test tool 150 by conducting various exchanges with server system 170 to implement a performance test of a network application service (not shown) of server system 170.

In an embodiment, the description of the performance test may include commands simulating user interactions with a UI of the network application—e.g. interactions to login to a user session of the network application. More particularly, a performance test script may include DSL-based commands having parameter values to specify information to be provided to a username field and/or a password field of a UI, for example. Based on these commands, the functional test tool may simulate to the performance test tool user input which initiates a user session of the network application under test. In certain embodiments, the test description generator 140 may additionally reuse one or more of these commands in the performance test script—e.g. to simulate repeated user login operations. For example, test description generator 140 may repeatedly include these commands in the description of the performance test—either explicitly or through any of a variety of iteration statements—wherein parameter values of the commands are selectively varied to represent variety across a plurality of user login operations. This reuse of commands with selective variation of parameter values may, for example, allow the functional test tool to simulate to the performance test tool user input to initiate various user sessions of the same one user and/or initiate various respective user sessions of multiple users.

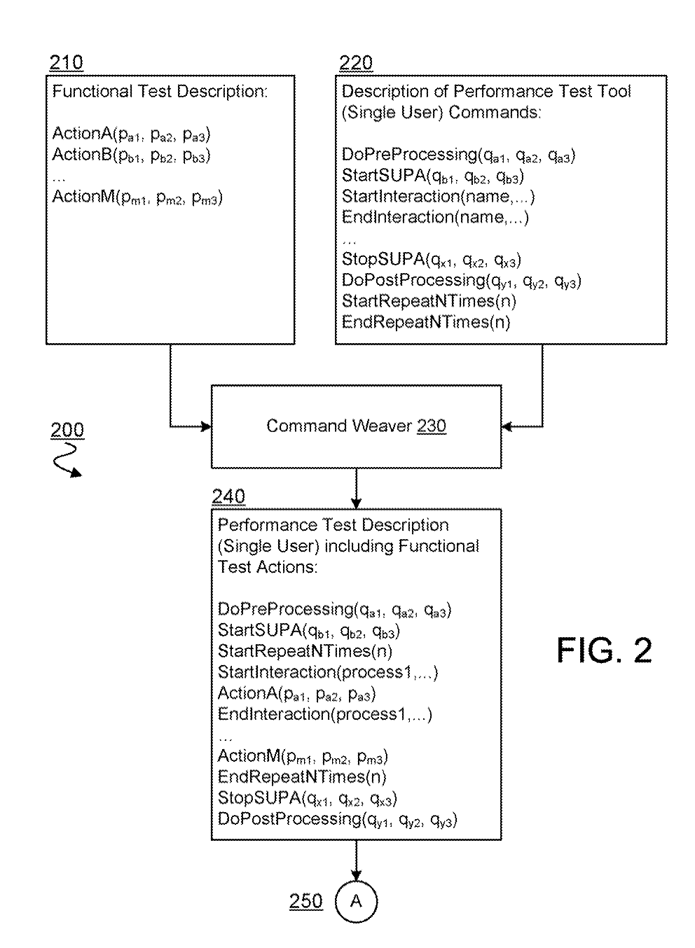

FIG. 2 illustrates select elements of a system 200 to generate a description 240 of a performance test according to an embodiment. Elements of system 200 may include one or more elements of system 100, for example. In an embodiment, system 200 may include, generate, retrieve or otherwise access a functional test description 210 and a description of performance test tool commands 220. In the illustrative case of FIG. 2, system 200 may generate a description of a performance test 240 for single user performance analysis (SUPA)—e.g. a test to evaluate a load on a server system providing a network application as a service to only one user. In an embodiment, a performance test to evaluate an application server system providing a network application service may test the performance of one or more server system security mechanisms to protect the providing of the service—e.g. encryption/decryption processes, data backup methods, authentication/authorization access controls, firewalls, etc. For embodiments implementing SUPA, the performance test tool may be a monitoring tool (e.g. the monitoring tool of SAP NetWeaver® Administrator provided by SAP Aktiengesellschaft) whose operation is controlled by a functional test tool. Functional test description 210 and description 200 may represent, for example, information in functional test description 120 and performance test information 130, respectively. In an embodiment, functional test description 210 may include a description of a series of commands (or ‘actions’ as used herein)—e.g. ActionA, ActionB, . . . , ActionM—representing interactions with a UI of a network application to be tested by system 200. The actions of functional test description 210 may be described according to a functional definition of a DSL which abstracts the modeling of user inputs—e.g. by describing functions independent of one or more process logic contexts of the application under test. By way of illustration, parameters pₐ₁, pₐ₂, pₐ₃ of an ActionA in functional test description 210 may represent values for parameters corresponding to the <framename>, <linkname> and <location> parameters described herein with respect to functional library 110. Functional test description 210 may include any of a variety of alternative combinations of actions and/or parameters thereof, according to various embodiments described herein.

The description of SUPA test tool commands 220 may include descriptions of any of a variety of combinations of commands for a SUPA test tool. By way of illustration, the description of SUPA test tool commands 220 may describe one or more of a DoPreProcessing command for processes prior to and/or in preparation of a SUPA test session, a DoPostProcessing command for processes subsequent to completion of a SUPA test session, a StartSUPA command to initiate a SUPA test session and/or a StopSUPA command to end a SUPA test session. An example for a preprocessing step for SUPA might be to ensure that no other processes/browsers are currently running, which ensures that there is no external influence during the performance test. Postprocessing for SUPA might be any transformation of a report that SUPA generates, such as filtering out invalid tests runs, as well as putting the reports into a database for future analysis. Alternatively or in addition, the description of SUPA test tool commands 220 may describe a StartInteraction command to initiate or otherwise connote the beginning of a sequence of commands modeling user input to a UI of the network application under test. Similarly, the description of SUPA test tool commands 220 may describe an EndInteraction command to terminate or otherwise connote an end of said sequence of commands modeling user input to the network application's UI. In an embodiment, commands such as StartInteraction and EndInteraction may allow a performance test tool to distinguish commands describing user interactions with an interface of the test tool—e.g. to manage a performance test session—from commands describing user interactions with the UI of the application under test during said performance test session. Alternatively or in addition, the description of SUPA test tool commands may describe commands to control iterative execution of commands by the SUPA test tool. For example, commands StartRepeatNTimes and EndRepeatNTimes may be used to demark regions of code which are to be iteratively executed.

System 200 may additionally include command weaver 230 to combine or “weave” various commands of functional test description 210 and the description of SUPA test tool commands 220 to generate performance test description 240. In an embodiment, command weaver 230 may include any of a variety of software and/or hardware logic of test description generator 140, for example. Command weaver 230 may access functional test description 210 and the description of performance test tool commands 220 to generate performance test description 240. More particularly, command weaver 230 may selectively incorporate, interleave, or otherwise combine into performance test description 240 actions in functional test description 210 and actions in the description of performance test tool commands 220. Performance test description 240 generated by command weaver 230 may include commands to cause a functional test tool to automate operation of a SUPA test tool. Automating operation of a SUPA test tool by a functional test tool may be achieved at least in part by combining commands to control the recording of performance indicators by the SUPA test tool with commands to cause the SUPA test tool to initiate the type of application server performance which is to be recorded—e.g. by simulating UI input for the network application under test. In an embodiment, system 200 may provide, at A 250, the generated performance test description 240 to one or more external systems implementing functional test tool, a performance test tool and/or a server system under test. In an alternate embodiment, one or more of the functional test tool, the performance test tool and the server system are included in server system 200.

An illustrative set of pseudocode test commands for a single user performance test according to one embodiment may be as follows:

```
// Start preprocessing in preparation for SUPA test session
// In this case, preprocessing requires more than a one line command DoPreprocessing
StartPreprocessing
    // Initialize files <filename1>,..., <filenameN> to receive key performance
    // indicator information
    InitPKIFile(<filename1>)
    ...
    InitPKIFile(<filenameN>)
    // Open data channels <channel1>,...,<channelM> with server <svrID> to receive
    // KPI information
    OpenSvrPKIChannel(<channel1>, <svrID>)
    ...
    OpenSvrPKIChannel(<channelM>, <svrID>)
```

| | |
|---|---|
| DetectSvrProcesses(<svrID>) | // Determine currently running server |
| | // processes |

| | |
|---|---|
| StartSvrProcess(<svrID>, <appname1>)) | // Begin processes associated with |
| | // performance test |
| StopSvrProcess(<svrID>, <appname2>)) | // End processes excluded from |
| | // performance test |

```
    // Initialize monitoring functions F1,...,FX of SUPA tool
    InitMonitorFunction(F1)
    ...
    InitMonitorFunction(FX)
    // Assign monitoring functions to output to respective file(s)
    AssignFunctionOutput(F1, <filename1>)
    ...
    AssignFunctionOutput(FX, <filenameN>)
    ...
StopPreprocessing
// Start SUPA test session <sessionname>
StartSUPA(<sessionname>)
    // Start a user interaction process <process1> with a network application UI
    StartInteraction(<process1>)
        // Begin trigger for functional test commands of <FunctionTest1> to be
        // passed into the description of the performance test. These trigger
        // commands (!) may be variously replaced with functional commands by
        // the test description generator or otherwise ignored by the functional test
        // tool
        !BeginTriggerTestDescriptionGenerator
            !InsertFunctionalTest(<FunctionTest1>)
        !EndTriggerTestDescriptionGenerator
    // End the user interaction process <process1>
    EndInteraction(<process1>)
    // Start a user interaction process <process2> with the network application UI
    StartInteraction(<process2>)
        // Insert additional functional commands
        ! BeginTriggerTestDescriptionGenerator
            ! InsertFunctionalTest(<FunctionTest2>)
        ! EndTriggerTestDescriptionGenerator
    // End the user interaction process <process2> with UI
    EndInteraction(<process2>)
// End SUPA test session <sessionname>
StopSUPA(<sessionname>)
StartPostProcessing
    // Stop monitoring functions F1,...,FX of SUPA tool
    StopMonitorFunction(F1)
    ...
    StopMonitorFunction(FX)
```

| | |
|---|---|
| StopSvrProcess(<svrID>, <appname1>)) | //End processes associated with |
| | // performance test |
| StartSvrProcess(<svrID>, <appname2>)) | //Resume previously stopped server |
| | // processes, if needed |

```
    // Close data channels <channel1>,...,<channelM>
    CloseSvrPKIChannel(<channel1>)
    ...
    CloseSvrPKIChannel(<channelM>)
    // Close files <filename1>,..., <filenameN>
    ClosePKIFile(<filename1>)
    ...
    ClosePKIFile(<filenameN>)
    //Perform processing of data in PKI files
    CollatePKIFiles(<filename1>,...,<filenameN>)
    AggregatePKIFiles(<filename1>,...,<filenameN>)
    BatchPKIFiles(<filename1>,...,<filenameN>)
StopPostProcessing
```

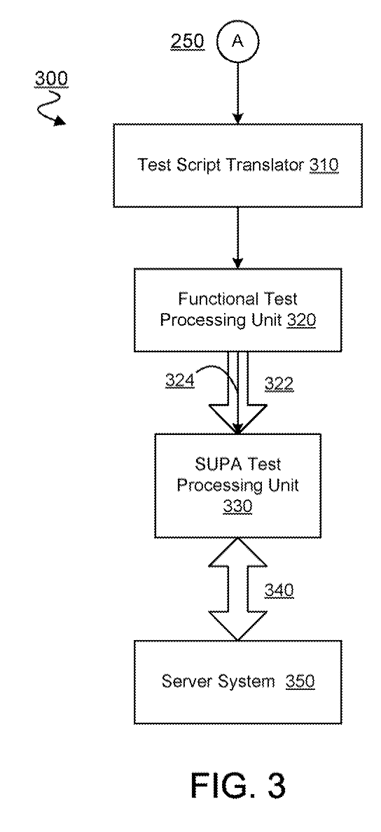

FIG. 3 illustrates select elements of a system 300 to implement a performance test according to an embodiment of the invention. In an embodiment, one or more elements of system 300 may be included in system 200. Alternatively, system 200 may be external to system 300 and may provide a performance test description 240 for use according to techniques described herein. System 300 may include a test script translator 310 to receive a performance test description, for example performance test description 240 received at 250.

Test script translator 310 may translate the received performance test description into a test script format suitable for processing by a functional test processing unit 320 in system 300. Test script translator 310 may provide the resulting test script to functional test processing unit 320, whereupon functional test processing unit 320 may automate a performance test according to the received test script. In an embodiment, functional test processing unit 320 may, in response to executing the received test script, send signals 322 to a SUPA test processing unit 330 of system 300. Signals 322 may include control messages to determine how a recording of performance test indicators is to be managed by SUPA test processing unit 330. Additionally, signals 322 may include messages 324 to cause SUPA test processing unit 330 to simulate UI input for a network application under test. In response to signals 322, SUPA test processing unit 330 may conduct a performance test exchange 340 with a server system 350 of system 300 which hosts the application under test. Performance test exchange 340 may include communications responsive to messages 324 to initiate operations of server system 350 which are to be subject to a performance test. Additionally or alternatively, performance test exchange 340 may include values sent from server system 350 to SUPA test processing unit 330 for performance indicators of said performance by server system 350.

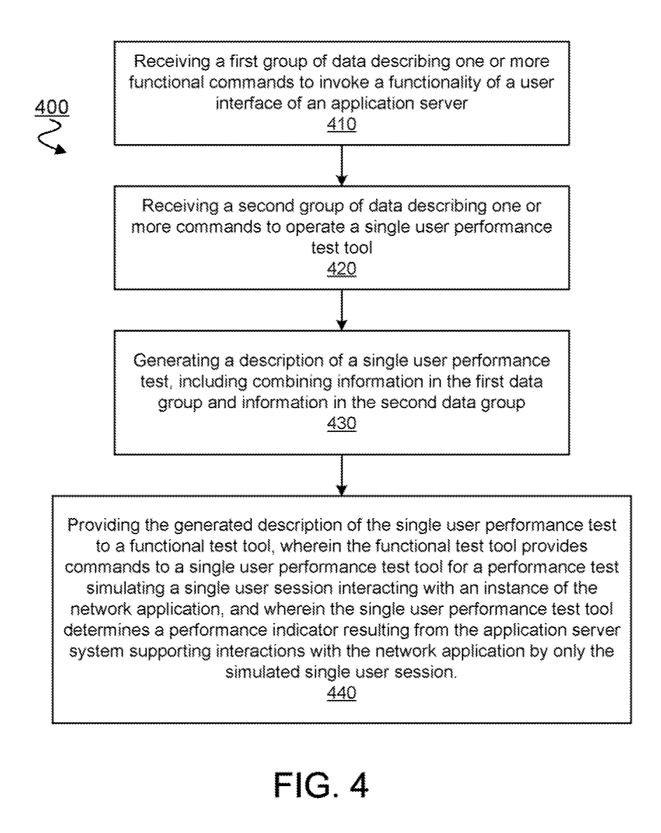

FIG. 4 illustrates select elements of a method for generating a description of a performance test according to an embodiment of the invention. In an embodiment, method 400 may be performed by test description generator 140 and/or corresponding elements of system 200—e.g. command weaver 230. Method 400 may include receiving, at 410, a first group of data describing one or more functional commands to interact with a UI of an application server—e.g. of a network application executed by the application server. Additionally, method 400 may include receiving, at 420, a second group of data describing one or more commands to operate a single user performance test tool. Based on the received first and second sets of data, method 400 may generate, at 430, a description of a single user performance test, including combining information in the first data group and information in the second data group. The generated single user performance test may then be provided, at 440, to a functional test tool for execution thereby, wherein the functional test tool provides commands to a single user performance test tool for a performance test simulating a single user session interacting with an instance of the network application. In an embodiment, the single user performance test tool determines a performance indicator resulting from the application server system supporting interactions with the network application by only the simulated single user session.

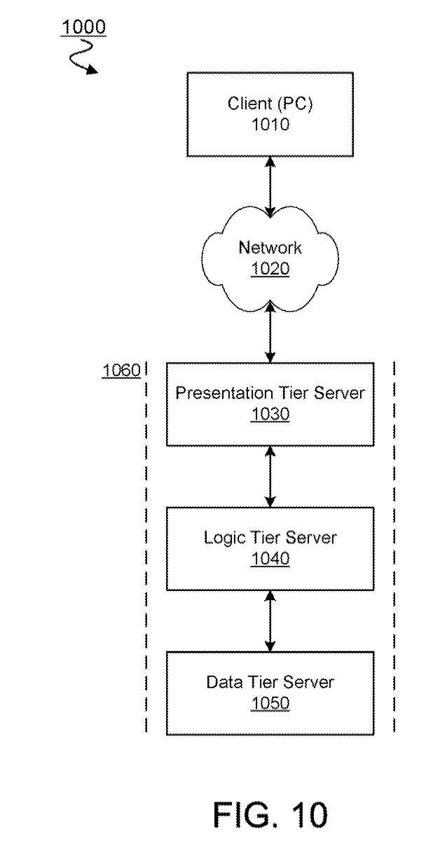

FIG. 10 illustrates select elements of a 3-tier client-server architecture which may be performance tested according to an embodiment. System 1000 may include a client 1010 such as a personal computer (PC) or other data processing device which communicates with and receives a service from tiered servers, e.g. via a network 1020. The tiered server structure of system 1000 is merely illustrative of one type of system which may be performance tested according to one embodiment. In this illustrative example, system 1000 may include a data tier server 1050 including one or more services to store and/or access data sets which are utilized and/or processed in the implementation of one or more services to be provided to client 1010. In an embodiment, data tier server 1050 may include one or more dedicated data servers to manage the storing and accessing of information stored in a database system (not shown). System 1000 may further include a logic tier server 1040 in communication with data tier server 1050 to execute or otherwise implement software such as a network application to exploit and/or process data managed by data tier server 1050. In an embodiment, the network application may include any of a variety of enterprise resource planning applications, for example. System 1000 may further include a presentation tier server 1030 in communication with logic tier server 1040 and including a service to represent to client 1010 the front end of the software executed by logic tier server 1040. In an embodiment, presentation tier server 1030 may include a web server to present a UI to a user of client 1010—e.g. via a browser program (not shown) executing on client 1010. It is understood that presentation tier server 1030, logic tier server 1040 and/or data tier server 1050 may be implemented each in one or more physical servers, virtual machines and/or other server instances according to various embodiments.

For application development, it is often desirable to execute a performance test which accounts for the operation of multiple tiers of a tiered server system, e.g. by performing a ‘vertical’ evaluation 1060 of presentation tier server 1030, logic tier server 1040 and data tier server 1050. In various embodiments, vertical evaluation 1060 may be extended to include evaluation of performance indicators related to the operation of client 1010, for example. Vertical evaluation 1060 may, for example, help determine the overall loads and/or inefficiencies of the tiered client-server system as a whole in providing a network application service. By way of illustration, vertical evaluation 1060 may evaluate overall times for client 1010 to receive and/or represent graphical UI data, total runtime delays for specific client/server processes, memory consumption for specific processes, consumption of networking bandwidth and/or consumption of other computer system resources. In certain cases, vertical evaluation 1060 may be particularly directed to performance evaluation for only a single user's interactions with the tiered servers. In such cases, a performance testing tool such as SUPA test processing unit 330 may, for example, implement a performance test to retrieve the value of performance test indicators which reflect—either individually or in combination—the processing loads, operating inefficiencies, etc. of every one of presentation tier server 1030, logic tier server 1040 and data tier server 1050 in responding to only one user's UI interactions. SUPA indicators may include, for example, client CPU time for a browser to perform a step of a rendering process, memory usage of a client browser in supporting interactions with a network application, and/or a size of data transferred by a server and/or a client in support of a particular user interaction.

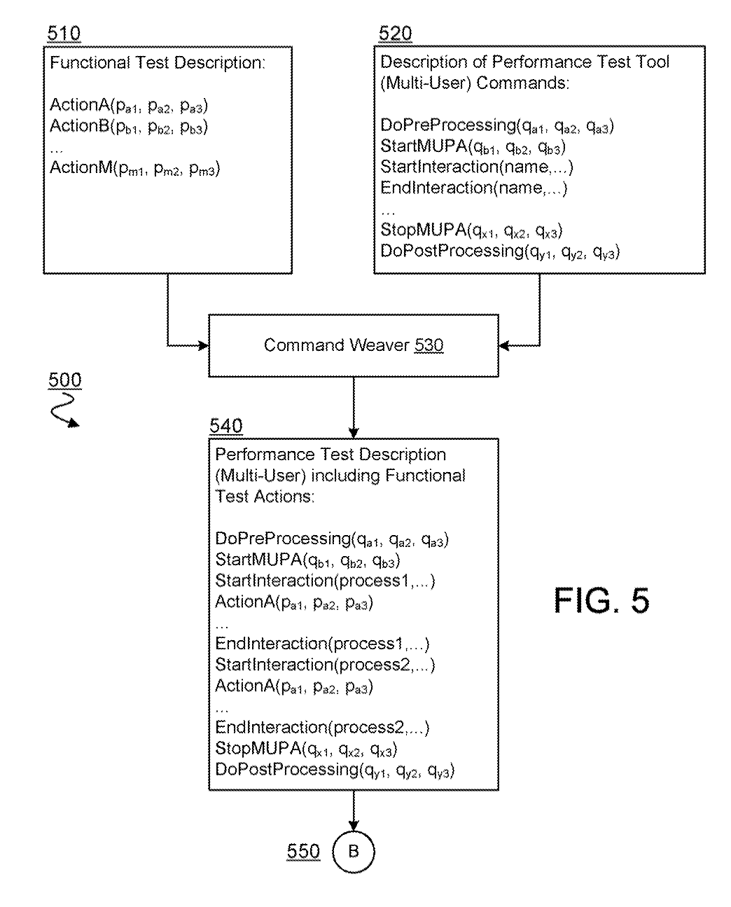

FIG. 5 illustrates select elements of a system 500 to generate a description 540 of a performance test according to an embodiment. Elements of system 500 may include or otherwise correspond to one or more elements of system 100, for example. In an embodiment, system 500 may include, generate, retrieve or otherwise access a functional test description 510 and a description of performance test tool commands 520. In the illustrative case of FIG. 5, system 500 generates a description of a performance test 540 for multiple user performance analysis (MUPA)—e.g. a test to evaluate the load on a server system providing a network application as a service to a plurality of users. For embodiments implementing MUPA, the performance test tool may be a recording tool such as HP Loadrunner® whose operation is controlled by a functional test tool. In such an embodiment, an output of the functional test tool may be a test script defined in the HP Loadrunner® testing language. In an embodiment, a performance test tool may, based on the HP Loadrunner® test script, record network traffic from multiple user sessions and replay to a server system hosting the network application the recorded network traffic. By replaying the network traffic, the performance test tool may generate during the performance test server system conditions which are then detected and evaluated as performance indicators associated with the providing of the network application service. This HP Loadrunner® test script can further be used and reused by HP Loadrunner® to generate one or more performance reports in an automatic post-processing phase directed by the functional test tool.

Functional test description 510 and description 500 may represent, for example, information in functional test description 120 and performance test information 130, respectively. In an embodiment, functional test description 510 may include a description of a series of actions—e.g. ActionA, ActionB, . . . , ActionM—representing interactions with a UI of a network application to be tested by system 500. The actions of functional test description 510 may be described according to a DSL which abstracts the modeling of user inputs—e.g. by describing functions independent of one or more process logic contexts of the application under test. By way of illustration, functional test description 510 may include commands described according to a DSL functional library such as that discussed with respect to FIG. 1.

The description of MUPA test tool commands 520 may include descriptions of any of a variety of combinations of commands for a MUPA test tool. By way of illustration, the description of MUPA test tool commands 520 may describe one or more of a DoPreProcessing command for processes prior to or in preparation of a MUPA test session, a DoPostProcessing command for processes subsequent to completion of a MUPA test session, a StartMUPA command to initiate a MUPA test session and/or a StopMUPA command to end a MUPA test session. An example for a preprocessing step for MUPA might be to ensure that no other processes/browsers are currently running, which ensures that there is no external influence during the performance test. Postprocessing for MUPA might be any transformation of report that MUPA generates, such as filtering out invalid tests runs, as well as putting the reports into a database to be able to compare them over time. Alternatively or in addition, the description of MUPA test tool commands 520 may describe a StartInteraction command to initiate or otherwise connote the beginning of a sequence of commands to provide UI input for the network application under test. Similarly, the description of MUPA test tool commands 520 may describe an EndInteraction command to terminate or otherwise connote an end of said sequence of commands to provide UI input for the network application under test. In an embodiment, commands such as StartInteraction and EndInteraction may allow a performance test tool to distinguish commands describing user interactions with an interface of the test tool—e.g. to manage a performance test session—from commands describing user interactions with the UI of the application under test during said performance test session. Alternatively or in addition, the description of MUPA test tool commands may describe commands to control iterative execution of commands by the MUPA test tool. For example, commands StartRepeatNTimes and EndRepeatNTimes may be used to demark regions of code which are to be iteratively executed.

System 500 may include a command weaver 530 to combine or “weave” various commands of functional test description 510 and the description of MUPA test tool commands 520 to generate a performance test description 540. In an embodiment, command weaver 530 may represent one or more of a software routine, method call, object, thread, state machine, ASIC or similar logic of test description generator 140, for example. Command weaver 530 may access functional test description 510 and the description of performance test tool commands 520 to generate performance test description 540. More particularly, command weaver 530 may selectively incorporate, interleave, or otherwise combine into the performance test description 540 actions in functional test description 510 and actions in the description of performance test tool commands 520. The performance test description 540 generated by command weaver 530 may include commands to cause a functional test tool to automate operation of a MUPA test tool. Automating operation of a MUPA test tool by a functional test tool may be achieved at least in part by combining commands to control the recording of performance indicators by the MUPA test tool with commands to cause the MUPA test tool to initiate the type of application server performance which is to be recorded—e.g. by simulating UI input for the network application under test. In an embodiment, system 500 may provide, at B 550, the generated performance test description 540 to one or more external systems implementing functional test tool, a performance test tool and/or a server system under test. In an alternate embodiment, one or more of the functional test tool, the performance test tool and the server system are included in server system 500.

An illustrative set of pseudocode test commands for a multiple user performance test according to one embodiment may be as follows:

```
// Start preprocessing in preparation for MUPA test session
// In this case, preprocessing requires more than a one line command DoPreprocessing
StartPreprocessing
    // Initialize file <filename1> to record network traffic during user interactions
    InitRcrdFile(<filename1>)
    // Initialize file <filename2> to receive key performance indicator
    // information during replaying of recorded network traffic
    InitPKIFile(<filename2>)
    // Open data channel with server <svrID> to receive network traffic for recording
    OpenSvrRcrdChannel(<channel1>, <svrID>)
    // Open data channel with server <svrID> to receive KPI information during
    replay of recording
    OpenSvrPKIChannel(<channel2>, <svrID>)
```

| | |
|---|---|
| DetectSvrProcesses(<svrID>) | // Determine currently running server |
| processes | |

| | |
|---|---|
| StartSvrProcess(<svrID>, <appname1>)) | //Begin processes associated with |
| | // performance test |
| StopSvrProcess(<svrID>, <appname2>)) | //End processes excluded from |
| | // performance test |

```
    // Initialize recording function RF1 of MUPA tool
    InitRcrdFunction(RF1)
    // Initialize monitoring functions F1,...,FX of MUPA tool
    InitMonitorFunction(F1)
    ...
    InitMonitorFunction(FX)
    // Assign recording function to output to file
    AssignRcrdFunctionOutput(RF1, <filename1>)
    // Assign monitoring functions to output to respective file(s)
    AssignFunctionOutput(F1,..., FX, <filename2>)
    ...
StopPreprocessing
// Start MUPA test session <sessionname>
StartMUPA(<sessionname>)
    //Start recording network traffic
    StartRcrd(RF1)
        // Start a user interaction process <process1> with a network
        // application UI
        StartInteraction(<process1>)
            // Begin trigger for functional test commands of <FunctionTest1>
            // to be passed into the description of the performance test. These
            // trigger commands (!) may be variously replaced with functional
            // commands by the performance test generator or otherwise
            // ignored by the functional test tool
            !BeginTriggerTestDescriptionGenerator
                !InsertFunctionalTest(<FunctionTest1>)
            !EndTriggerTestDescriptionGenerator
        // End the user interaction process <process1>
        EndInteraction(<process1>)
    //End recording of network traffic
    EndRcrd(RF1)
    // Replay N instances of simulated interactions based on the traffic
    // recorded to <filename 1>. Key performance indicators (KPI)s will be retrieved
    // by F1,...,FX
    StartMUPAInteraction(<process2>)
        InitiateSessionInstances(<filename 1>, N)
    EndInteraction(<process2>)
// End MUPA test session <sessionname>
StopMUPA(<sessionname>)
StartPostProcessing
    // Stop record function RF1 of MUPA tool
    StopRcrdFunction(RF1)
    // Stop monitor function F1
    // Stop monitoring functions F1,...,FX of MUPA tool
    StopMonitorFunction(F1)
    ...
    StopMonitorFunction(FX)
```

| | |
|---|---|
| StopSvrProcess(<svrID>, <appname1>)) | //End processes associated with |
| | // performance test |
| StartSvrProcess(<svrID>, <appname2>)) | //Resume previously stopped server |
| | // processes, if needed |

```
    // Close data channel to receive network traffic for recording
    CloseSvrRcrdChannel(<channel1>)
    // Close data channel to receive KPI information during replay of recording
    CloseSvrPKIChannel(<channel2>)
    // Close files <filename1>, <filename2>
    CloseRcrdFile(<filename1>)
    ClosePKIFile(<filename2>)
    //Perform processing of data in PKI files
    CollatePKIFiles(<filename1>,...,<filenameN>)
    AggregatePKIFiles(<filename1>,...,<filenameN>)
    BatchPKIFiles(<filename1>,...,<filenameN>)
StopPostProcessing
```

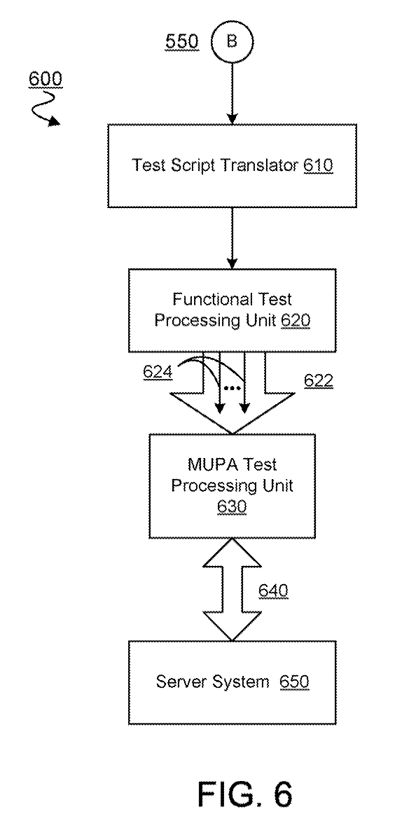

FIG. 6 illustrates select elements of a system 600 to implement a performance test according to an embodiment of the invention. In an embodiment, one or more elements of system 600 may be included in system 500. Alternatively, a system 500 external to system 600 may in various embodiments provide a performance test description 540 for use according to techniques described herein. System 600 may include a test script translator 610 to receive a performance test description, for example performance test description 540 received at 550.

Test script translator 610 may translate the received performance test description into a test script format suitable for processing by a functional test processing unit 620 in system 600. Test script translator 610 may provide the resulting test script to functional test processing unit 620, whereupon functional test processing unit 620 may automate a performance test according to the received test script. In an embodiment, functional test processing unit 620 may, in response to executing the received test script, send signals 622 to MUPA test processing unit 630—e.g. the HP LoadRunner® tool—of system 600. Signals 622 may include control messages to determine how a recording of performance test indicators is to be managed by MUPA test processing unit 630. Additionally, signals 622 may include plural messages 624 to cause MUPA test processing unit 630 to simulate multiple users' respective UI inputs for a network application under test. In response to signals 622, MUPA test processing unit 630 may conduct a performance test exchange 640 with a server system 650 of system 600 hosting the application under test. Performance test exchange 640 may include communications responsive to messages 624 to initiate the type of performance of server system 650 which is to be recorded. Additionally or alternatively, performance test exchange 640 may include data sent from server system 650 to MUPA test processing unit 630 which describes performance indicators of said performance by server system 650.

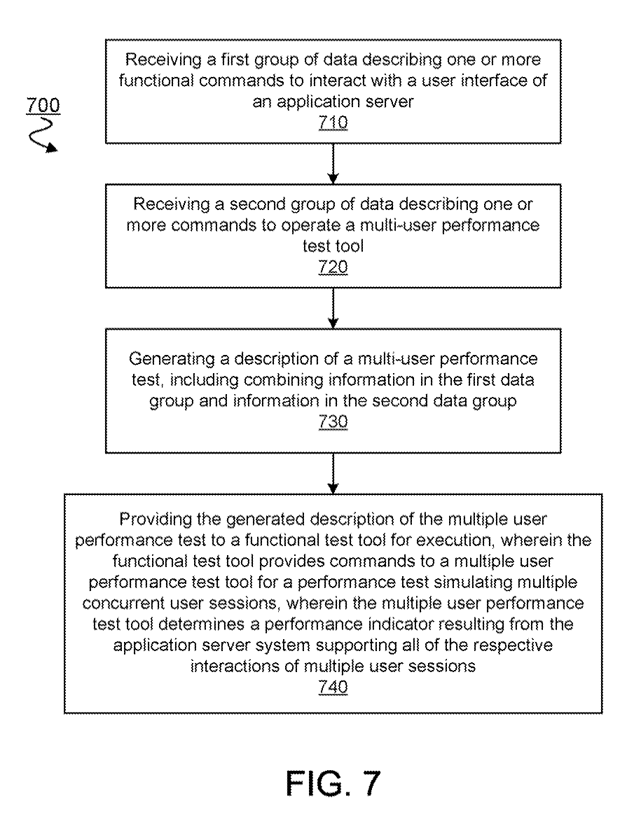

FIG. 7 illustrates select elements of a method for generating a description of a performance test according to an embodiment of the invention. In an embodiment, method 700 may be performed by test description generator 140 and/or corresponding elements of system 500—e.g. command weaver 530. Method 700 may include receiving, at 710, a first group of data describing one or more functional commands to interact with a UI of a network application of an application server. Additionally, method 700 may include receiving, at 720, a second group of data describing one or more commands to operate a multiple user performance test tool. Based on the received first and second sets of data, method 700 may generate, at 730, a description of a multiple user performance test, including combining information in the first data group and information in the second data group. The generated multiple user performance test may then be provided, at 740, to a functional test tool for execution, wherein the functional test tool provides commands to a multiple user performance test tool for a performance test simulating multiple concurrent user sessions, each simulated user session including a respective interaction with an instance of the network application. In an embodiment, the multiple user performance test tool may determine a performance indicator resulting from the application server system supporting all of the respective interactions of multiple user sessions

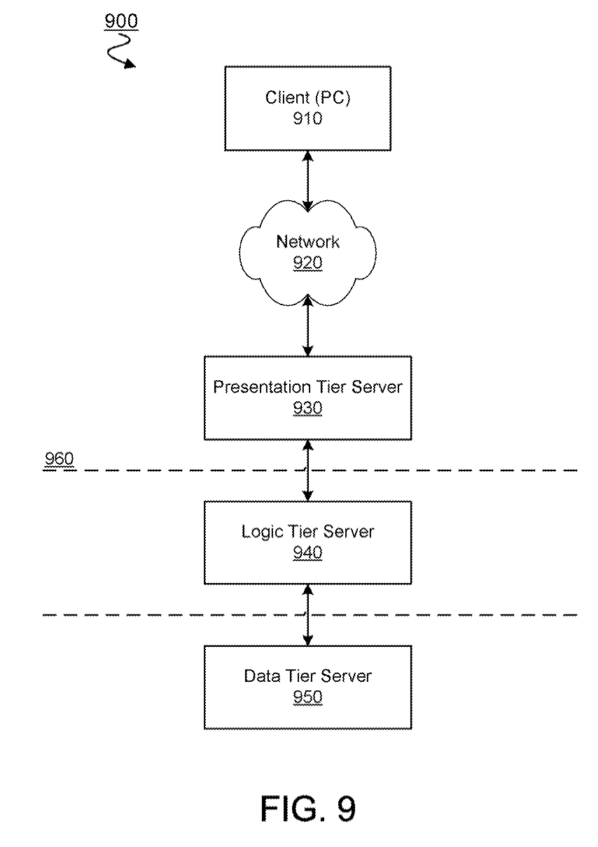

FIG. 9 illustrates select elements of a so-called “3-tier” client-server architecture which may be performance tested according to an embodiment. System 900 may include a client 910 such as a personal computer (PC) or other data processing device which communicates with and receives a service from tiered servers, e.g. via a network 920. The tiered server structure of system 900 is merely illustrative of one type of system which may be performance tested according to one embodiment. In this illustrative example, system 900 may include a data tier server 950 including one or more services to store and/or access data sets which are utilized and/or processed in the implementation of one or more services to be provided to client 910. In an embodiment, data tier server 950 may include one or more dedicated data servers to manage the storing and accessing of information stored in a database system (not shown). System 900 may further include a logic tier server 940 in communication with data tier server 950 to execute or otherwise implement software such as a network application to exploit and/or process data managed by data tier server 950. In an embodiment, the network application may include any of a variety of enterprise resource planning programs, for example. System 900 may further include a presentation tier server 930 in communication with logic tier server 940 and including a service to represent to client 910 the front end of the software executed by logic tier server 940. In an embodiment, presentation tier server 930 may include a web server to present a UI to a user of client 910—e.g. via a browser program (not shown) executing on client 910. It is understood that presentation tier server 930, logic tier server 940 and/or data tier server 950 may be implemented each in one or more physical servers, virtual machines and/or other server instances according to various embodiments.

For application development, it is often desirable to execute a performance test which is focused on the operation of only one particular tier of a tiered server system, e.g. by performing a ‘horizontal’ evaluation 960 of only the logic tier server 940 executing the network application. More particularly, it may be useful in such cases to exclude from a performance test evaluations of other processes—e.g. exclude individual PC rendering processes, database communication times, etc.—that are implemented on other server tiers. In such cases, a performance testing tool such as MUPA test processing unit 630 may implement a performance test to retrieve the value of performance test indicators which reflect only processing loads, operating inefficiencies, etc. which are specific to logic tier server 940.

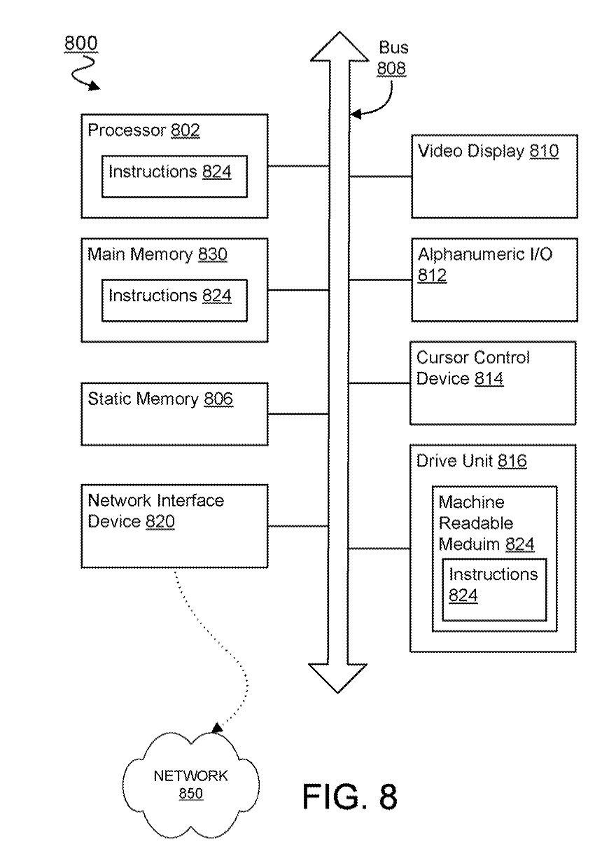

FIG. 8 illustrates select elements of an exemplary form of a computer system 800 within which a group of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, or any machine capable of executing a group of instructions (sequential or otherwise) that specify actions to be taken by that machine. Further, while only a single machine is illustrated, the term “machine” shall also be taken to include any collection of machines that individually or jointly execute a group (or multiple sets) of instructions to perform any one or more of the methodologies discussed herein.

The exemplary computer system 800 may include a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)) to implement displays generated according to techniques set forth herein. The computer system 800 may also include an alphanumeric input device 812 (e.g., a keyboard), a user interface (UI) navigation device 814 (e.g., a mouse), a disk drive unit 816 and/or a network interface device 820.

The disk drive unit 816 may include a machine-readable medium 822 on which is stored one or more sets of instructions and data structures (e.g., software 824 ) embodying or utilized by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media. The software 824 may further be transmitted or received over a network 826 via the network interface device 820 utilizing any one of a number of well-known transfer protocols (e.g., HTTP).

While the machine-readable medium 822 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a group of instructions for execution by the machine and that cause the machine to perform any one or more of the methodologies of the present invention, or that is capable of storing or encoding data structures utilized by or associated with such a group of instructions. The term “machine-readable medium” shall accordingly be taken to include, but not be limited to, solid-state memories, optical and magnetic media, etc.

Techniques and architectures for performance testing of an application server are described herein. In the description herein, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, e.g. the apparatus can be implemented as special purpose logic circuitry, e.g., an FPGA (field programmable gate array) or an ASIC (application specific integrated circuit). Alternatively or in addition, the apparatus may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, the present invention is not described with reference to any particular programming language. It will be appreciated that a variety of programming languages may be used to implement the teachings of the invention as described herein.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

What is claimed is:

1. A method comprising
receiving a first group of data describing one or more functional commands to invoke a functionality of a network application hosted by an application server system via a user interface of the network application;
receiving a second group of data describing one or more commands to operate a single user performance test tool;
generating in a memory a description of a single user performance test, including combining information in the first data group and information in the second data group; and
providing the generated description of the single user performance test to a functional test tool for execution, wherein the functional test tool provides commands to a single user performance test tool for a performance test simulating a single user session interacting with an instance of the network application, and wherein the single user performance test tool determines a performance indicator resulting from the application server system supporting the interactions of only the simulated single user session.

2. The method of claim 1, wherein the application server system is a tiered server system, and wherein the performance indicator describes a combined operation of two or more of a presentation tier of the application server system, a logic tier of the application server system and a data tier of the application server system.

3. The method of claim 1, wherein the commands provided by the functional test tool include a command simulating a user interaction with an interface of the performance test tool.

4. The method of claim 3, wherein the commands provided by the functional test tool further includes a command simulating a user interaction with an interface of the network application during the performance test.

5. The method of claim 1, wherein the one or more functional commands include a command describing according to a domain specific language an interaction with a user interface element.

6. The method of claim 5, wherein the command describing the interaction with the user interface element does not reference any internal data processing for a functionality of the network application invoked via the user interface element.

7. A method comprising:
receiving at a functional test tool a description of a single user performance test including,
data describing one or more functional commands to invoke functionality of a network application hosted by an application server system, the invoking via a user interface of the network application, and
data describing one or more commands to operate a single user performance test tool;
executing the description of the single user performance test by the functional test tool, including providing from the functional test tool to a single user performance test tool commands for a performance test simulating a single user session interacting with an instance of the network application, wherein the single user performance test tool determines a performance indicator resulting from the application server system supporting interactions with the network application by only the simulated single user session.

8. The method of claim 7, wherein the application server system is a tiered server system, and wherein the performance indicator describes an operation of two or more of a presentation tier of the application server system, a logic tier of the application server system and a data tier of the application server system.

9. The method of claim 7, wherein the commands provided by the functional test tool include
a command simulating a user interaction with an interface of the performance test tool, and
a command simulating a user interaction with an interface of the network application during the performance test.

10. The method of claim 7, wherein the one or more functional commands include a command describing according to a domain specific language an interaction with a user interface element, wherein the command describing the interaction with the user interface element does not reference any internal data processing for a functionality of the network application invoked via the user interface element.

11. A system comprising:
a test description generator to receive a first group of data describing one or more functional commands to interact with a user interface of network application hosted by an application server system, the test description generator further to receive a second group of data describing one or more commands to operate a single user performance test tool, the test description generator further to generate a description of a single user performance test, including combining information in the first data group and information in the second data group; and
a functional test tool to receive the generated description of a single user performance test from the test description generator, the functional test tool to automate a performance test according to the received description of a single user performance test, the performance test simulating a single user session interacting with an instance of the network application, the performance test further to determine a performance indicator resulting from the application server system supporting interactions with the network application by only the simulated single user session.

12. The system of claim 11, further comprising:
a single user performance test tool to receive from the functional test tool a group of signals generated automatically based on an execution of the description of the single user performance test, the group of signals including messages simulating user interactions with a user interface of the single user performance test tool to manage a performance test session to test the network application, the group of signals further including messages simulating user interactions with a user interface of the network application during the performance test session.

13. The system of claim 11, wherein one of the first and second groups of data describes a command according to a domain specific language.

14. The system of claim 13, wherein the command described according to a domain specific language includes a command to interact with a user interface element, wherein the command describing the interaction with the user interface element does not reference any internal data processing of a functionality of the network application invoked via the user interface element.

15. The system of claim 11, wherein the description of a single user performance test includes one or more commands to distinguish to the single user performance test tool user interactions with an interface of the test tool to manage a performance test session from user interactions with the UI of the application under test during said performance test session.

16. A machine-readable medium having stored thereon instructions to cause one or more processors to perform a method comprising:
receiving a first group of data describing one or more functional commands to invoke a functionality of a network application hosted by an application server system via a user interface of the network application;
receiving a second group of data describing one or more commands to operate a single user performance test tool;
generating in a memory a description of a single user performance test, including combining information in the first data group and information in the second data group; and
providing the generated description of the single user performance test to a functional test tool for execution, wherein the functional test tool provides commands to a single user performance test tool for a performance test simulating a single user session interacting with an instance of the network application, and wherein the single user performance test tool determines a performance indicator resulting from the application server system supporting interactions with the network application by only the simulated single user session.

17. The machine-readable medium of claim 16, wherein the application server system is a tiered server system, and wherein the performance indicator describes an operation of two or more of a presentation tier of the application server system, a logic tier of the application server system and a data tier of the application server system.

18. The machine-readable medium of claim 16, wherein the commands provided by the functional test tool include a command simulating a user interaction with an interface of the performance test tool.

19. The machine-readable medium of claim 18, wherein the commands provided by the functional test tool further includes a command simulating a user interaction with an interface of the network application during the performance test.

20. The machine-readable medium of claim 16, wherein the one or more functional commands include a command describing according to a domain specific language an interaction with a user interface element.

21. The machine-readable medium of claim 20, wherein the command describing the interaction with the user interface element does not reference any internal data processing for a functionality of the network application invoked via the user interface element.
